(19) United States
(12) Patent Application Publication
(10) Pub. No.: US 2009/0260458 A1
(43) Pub. Date: Oct. 22, 2009

(54) HIGH THROUGHPUT DISPENSER

(76) Inventors: Victor Joseph, Fremont, CA (US); Joseph F. Rogers, Mountain View, CA (US); Kumar Kastury, San Jose, CA (US)

Correspondence Address: WILSON, SONSINI, GOODRICH & ROSATI, 650 PAGE MILL ROAD, PALO ALTO, CA, 94304-1050, US

(21) Appl. No.: 12/105,198

(22) Filed: Apr. 17, 2008

(51) Int. Cl. G01N 1/38

(52) U.S. Cl. 73/864.01; 422/100; 435/309.1

(57) ABSTRACT

The invention is directed to systems and methods for transferring nano-quantities of fluid samples using a high throughput or ultra high throughput dispenser. Such samples may be transferred from a first location and reformatted for being transferred to a second location. The invention may transfer a predetermined volume of sample quickly and accurately.

### BACKGROUND OF THE INVENTION

Today, the transfer of aqueous or liquid samples from one location to another occurs using different means. Small quantities of fluids may be transferred for several applications, such as analyzing samples on a microchip or microarray. For the transfer of nano-quantities of samples, several low throughput transfer applications exist. For instance, microvalves or piezo-based active serial dispensers may be used to dispense quantities of sample below approximately 1 μL. Micropipettes are commonly used to transfer quantities of sample greater than approximately 1 μL.

Such conventional methods are insufficient for transferring nano-quantities liquid samples for high throughput or ultra high throughput applications. Using microvalves or piezo-based active serial dispensers takes a great quantity of time, especially when the samples are coming from sources such as 96, 384, or 1536 microtiter plates. Such methods also result in dead volumes which cause sample wastage and carryover contamination. Conventional methods also lack compatibility for dispensing nano-quantities of samples to certain sample receiving formats, such as microchips. For instance, conventional methods lack flexibility for dispensing to a variety of formats, from 96, 384, and 1536 microtiter plates to 96, 384, and 1536 microchips especially.

Therefore, a need exists for systems and methods for high throughput or ultra high throughput transfer of fixed nano-quantities of samples, from a standard microtiter plate or a plurality of wells to microchips or microarrays or vice versa. Such systems and methods would greatly facilitate the transfer of samples relatively quickly and accurately.

### SUMMARY OF THE INVENTION

The invention provides systems and methods for transferring a sample using a high throughput dispenser. Various aspects of the invention described herein may be applied to any of the particular applications set forth below or for any other types of liquid handling or reformatting systems. The invention may be applied as a standalone system or method, or as part of an application, such as a diagnostic or polymerase chain reaction (PCR) assay. It shall be understood that different aspects of the invention can be appreciated individually, collectively, or in combination with each other.

One aspect of the invention provides a dispenser comprising (a) an array of capillaries for transfer of aqueous samples, said array comprising: a plurality of separate capillary channels each comprising a first end and a second end, wherein the first end is adapted to draw a predetermined volume of sample from a sample source; and a pressure source capable of operably connecting to the first ends of the plurality of separate capillary channels wherein the pressure source may effect a transfer of the predetermined volume of sample entirely from the first end to the second end; and (b) a support structure orienting the first end as a first footprint and orienting the second end as a second footprint, wherein the first footprint and second footprint have a different area.

In some embodiments, the sample source may be a multi-well plate comprising a plurality of source wells. For instance, the sample source may be a 96, 384 or 1536 microtiter plate. In some embodiments, the sample source may be a microtiter plate for holding polymerase chain reaction (PCR) samples.

In some other embodiments, the plurality of separate capillary channels may comprise 96 capillary channels, 384 capillary channels, or 1536 capillary channels. The plurality of separate capillary channels may include a plurality of separate capillary tubes. Capillary tubes may be made from materials such as glass, plastic, or a polymer. In some embodiments, the plurality of separate capillary channels may be fabricated from a method such as UV polymerization lithography, micro injection molding, hot embossing, graytone lithography or x-ray lithography.

The plurality of separate capillary channels comprises one or more preloaded reagents. The plurality of separate capillary channels may also draw a predetermined volume of sample, where the predetermined volume may be up to 100 nL. The first end of a capillary channel may be adapted to draw the predetermined volume of sample from the sample source using capillary action.

A pressure source may operably connect to the first ends of the plurality of separate capillary channels. In some embodiments, the pressure source may be a positive pressure chamber. A positive pressure chamber may exert a positive pressure greater than 3 atm into the plurality of separate capillary channels.

The second ends of a plurality of separate capillary channels may be directed to one or more sample receiving location. In some embodiments, the sample receiving location may be a microchip or microarray. The plurality of capillary channels may be capable of dispensing a hydrophilic liquid sample and hydrophobic liquid sample at the same time.

The support structure may have a first footprint and a second footprint where the first footprint has a greater area than the second footprint.

A dispensing kit may comprise the dispenser as discussed, and instructions for use thereof.

An alternate aspect of the invention may provide a dispenser comprising (a) an array of capillaries for transfer of aqueous samples, said array comprising: a plurality of separate capillary channels each comprising a first end and a second end; and (b) a support structure orienting the first end as a first footprint and orienting the second end as a second footprint, wherein each of the plurality of separate capillary channels have the substantially same volume capacity, wherein the first end is adapted to draw the same predetermined volume of sample from a sample source, and wherein the first footprint and second footprint have a different area.

In some embodiments, the sample source may be a multi-well plate comprising a plurality of source wells. For instance, the sample source may be a 96, 384 or 1536 microtiter plate. In some embodiments, the sample source may be a microtiter plate for holding polymerase chain reaction (PCR) samples.

In some other embodiments, the plurality of separate capillary channels may comprise 96 capillary channels, 384 capillary channels, or 1536 capillary channels. The plurality of separate capillary channels may include a plurality of separate capillary tubes. Capillary tubes may be made from materials such as glass, plastic, or a polymer. In some embodiments, the plurality of separate capillary channels may he fabricated from a method such as UV polymerization lithography, micro injection molding, hot embossing, graytone lithography or x-ray lithography.

In some embodiments, each of the plurality of separate capillary channels is effective to transfer the entire predetermined volume of sample from the first end to the second end.

The plurality of separate capillary channels may draw a predetermined volume of sample, where the predetermined volume may be up to 100 nL. The first end of a capillary channel may be adapted to draw the predetermined volume of sample from the sample source using capillary action. In some embodiments, the length of the plurality of separate capillary channels may be substantially the same. Alternatively, the length of the plurality of separate capillary channels may be substantially different.

A pressure source may operably connect to the first ends of the plurality of separate capillary channels. Each of the plurality of separate capillary channels may be effective to transfer the entire predetermined volume of sample using positive pressure from the first end. In some embodiments, the pressure source may be a positive pressure chamber. A positive pressure chamber may exert a positive pressure greater than 3 atm into the plurality of separate capillary channels.

The second ends of a plurality of separate capillary channels may be directed to one or more sample receiving location. In some embodiments, the sample receiving location may be a microchip or microarray. The plurality of capillary channels may be capable of dispensing a hydrophilic liquid sample and hydrophobic liquid sample at the same time.

The support structure may have a first footprint and a second footprint where the first footprint has a greater area than the second footprint

In an alternate embodiment of the invention, a dispenser may comprise an array of capillaries for transfer of aqueous samples, comprising: a plurality of separate capillary channels each comprising a first end and a second end; and a support structure orienting the first ends as a first footprint and orienting the second ends as a second footprint, wherein the first end is adapted to draw a predetermined volume of sample from a sample source, wherein the second end is adapted to dispense the predetermined volume of sample to a sample receiving location wherein both the second end and the sample receiving location are adapted to remain substantially stationary during the dispensing, and wherein the first footprint and second footprint have a different area.

In accordance with another aspect of the invention, a method of transferring of aqueous samples may comprise: receiving a sample from a sample source to a plurality of separate capillary channels each comprising a first end and a second end; drawing a predetermined volume of sample through the first end of each of the plurality of separate capillary channels using capillary action; applying positive pressure to the first end of each of the plurality of separate capillary channels; and dispensing the entire predetermined volume of sample through the second end of each of the plurality of separate capillary channels to a sample receiving location.

In some embodiments, the method may further comprise flipping the plurality of separate capillary channels to a degree sufficient for applying positive pressure to the first ends.

In other embodiments, the predetermined volume of sample drawn through the first end of each of the plurality of separate capillary channels may be the substantially same volume.

A system for dispensing may comprise, in accordance with one aspect of the invention: (a) a sample source; (b) an array of capillaries for transfer of a sample from the sample source, the array of capillaries comprising: a plurality of separate capillary channels each comprising a first end and a second end, wherein the first end is adapted to draw a predetermined volume of sample from the sample source, a pressure source capable of operably connecting to the first ends of the plurality of separate capillary channels wherein the pressure source may effect a transfer of the predetermined volume of sample entirely from the first end to the second end, and a support structure orienting the first ends as a first footprint and orienting the second ends as a second footprint, wherein the first footprint and second footprint have a different area; (c) a sample receiving location for receiving the predetermined volume of sample from the second end, wherein the sample receiving location contacts a temperature block; and (d) an optical detection device directed to the sample receiving location.

In some embodiments, the sample source may be a multi-well plate comprising a plurality of source wells. For instance, the sample source may be a 96, 384 or 1536 microtiter plate. In some embodiments, the sample source may be a microtiter plate for holding polymerase chain reaction (PCR) samples.

The second ends of a plurality of separate capillary channels may be directed to one or more sample receiving location. In some embodiments, the sample receiving location may be a microchip or microarray. In some embodiments, the sample receiving location is used for fluorescent or optical assay.

The temperature block provides heat to the sample receiving location in accordance with one embodiment of the invention.

Another aspect of the invention may provide for a sample transfer block, comprising: a plurality of separate capillary channels embedded therein, each comprising a first end and a second end, wherein the first end is adapted to draw a predetermined volume of sample from a sample source; a pressure source capable of operably connecting to the first ends of the plurality of separate capillary channels wherein the pressure source may effect a transfer of the predetermined volume of sample entirely from the first end to the second end; and a support structure orienting the first ends as a first footprint and orienting the second ends as a second footprint, wherein the first footprint and second footprint have a different area.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows several exemplary capillary tubes applied to sample wells.

FIG. 2 shows a profile of several exemplary capillary channels as well as a cross-sectional view of the surface that the capillary channels may contact.

FIG. 3A shows a side view of a support structure and a plurality of capillary channels.

FIG. 3B shows a close-up of a side of the support structure with a plurality of capillary channels.

FIG. 3C shows an exploded view of the layers making up the support structure and plurality of capillary channels.

FIG. 4A shows an exemplary layer of the support structure and plurality of capillary channels.

FIG. 4B shows a close-up of the layer of the support structure and plurality of capillary channels.

FIG. 5 shows several exemplary capillary tubes connected to an air pressure chamber.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for transferring a sample using a high throughput or ultra high throughput dispenser. A sample may be transferred from a sample source to a sample receiving location. A sample may be any fluid, liquid, or aqueous sample. For example, a sample may be a patient sample, a sample of bodily fluid, a chemical reagent used in applications such as polymerase chain reaction (PCR) or diagnostics, or an environmental sample. A sample source may contain one or more types of samples. For example, if a sample source is a multi-well plate, each well may contain a different sample. Alternatively, one or more of the samples may be the same.

Several examples of samples may include analytes or reagents. Some of the analytes or reagents may include, without limitation, an atom, organic or inorganic molecule, macromolecule, ion, compound, biological molecule, biologically active molecule, synthetic molecule, synthetic precursor, polymer, biological complex or cell. The sample may be transferred for applications such as PCR applications, environmental screening to detect pollutants, screening for biological or chemical warfare agents, forensic screening; security screening, diagnostic screening to detect indicators of disease, prognostic screening to detect indicators of drug efficacy or individual response to treatment; or research screening to identify desired agents such as drug candidates or industrially desirable agents. A sample may be transferred as a reagent for actions such as synthesis of a compound, extraction, washing, or sterilization.

In some embodiments, biological sample suspected to contain an analyte of interest, such as a target nucleic acid, can be used in conjunction with the subject system or devices. Biological samples may be derived from humans, animals, or plants, bodily fluids, solid tissue samples, tissue cultures or cells derived therefrom and the progeny thereof, sections of smears prepared from any of these sources, or any other samples suspected to contain analytes of interest. Commonly employed biological samples may include bodily fluids, which may include but are not limited to blood, serum, saliva, urine, gastric and digestive fluid, tears, stool, semen, vaginal fluid, interstitial fluids derived from tumorous tissue, ammoniac fluid, sinovial fluid, spinal fluid, and cerebrospinal fluid. Other types of biological sample may include food products and ingredients such as vegetables, dairy items, meat, meat by-products, and waste. Environmental samples are derived from environmental material including but not limited to soil, water, sewage, cosmetic, agricultural and industrial samples.

In one embodiment, the samples may be used directly for detecting the analytes present therein with the subject fluidic device without further processing. Where desired, however, the samples can be pre-treated before performing the analysis with the subject fluidic devices. The choice of pre-treatments may depend on the type of sample used and/or the nature of the analyte under investigation. For instance, where the analyte is present at low level in a sample of bodily fluid, the sample can be concentrated via any conventional means to enrich the analyte. Methods of concentrating an analyte include but are not limited to drying, evaporation, centrifugation, sedimentation, precipitation, and amplification. Where the analyte is a nucleic acid, it can be extracted using various lytic enzymes or chemical solutions according to the procedures set forth in Sambrook et al. (“Molecular Cloning: A Laboratory Manual”), or using nucleic acid binding resins following the accompanying instructions provided by manufactures. Where the analyte is a molecule present on or within a cell, extraction can be performed using lysing agents including but not limited to denaturing detergent such as SDS or non-denaturing detergent such as thesit, sodium deoxylate, triton X-100, and tween-20.

The sample source and the sample receiving location may be of different formats. For example, the sample source may have a first footprint area, (i.e. a designated area affected or covered by the device). The sample receiving location may have a second footprint area. In some embodiments of the invention, the footprint areas may be different. For example, the first footprint area may be greater than the second footprint area. Alternatively, the second footprint area may be greater than the first footprint area. In another embodiment of the invention, the footprint areas may be the same. For example, the sample source and the sample receiving location may have the same format, which may result in identical footprints. Alternatively, the sample source and the sample receiving location may have footprints of the same area but may have different formats.

The sample source may be any location or vessel capable of holding a sample. For example, a sample source may be a multi-well plate. Several examples of multi-well plate-type samples include 96, 384, and 1536 microtiter plates. Such sample plates may be of standard dimensions known in the art. For instance, such plates may have wells with a 2.25 mm, 4.5 mm, or 9 mm center to center pitch. Another example of a sample source may be a microcard, microchip, microarray, or substrate. Such sample sources may have any number of sample wells and sample well sizes. The sample wells may also have any cross-sectional shapes, such as rounded shapes, rectangular shapes, or any convex or concave shapes. The bottom of the wells may be flat, conical, pointed, or round. In some embodiments, sample wells from a sample source may be identical, while in other embodiments the wells may vary in different features. The sample wells may have any configuration. For example, the sample wells maybe arranged in a rectangular array, such as an 8×12 array for a 96 multi-well plate. Alternatively, the sample wells may be arranged in any format, which may or may not be rectangular, such as a line, curve, geometric shape, circle, spiral and so forth. In another implementation, the sample source may not comprise multiple wells, but may be from one or more vessels or reservoirs capable of holding a sample.

The sample receiving location may be any location or vessel capable of receiving the sample. The sample receiving location may include any of the formats possible for the sample source location. For instance, the sample receiving location may be a microcard, microchip or any microarray. A sample receiving location may also be a flat surface such as a slide, or a substrate. Such sample receiving locations may be adapted for receiving nano-quantities of sample. For example, microchips, may include mini-wells that are about 10 mm to about 100 μm in length, about 10 mm to about 100 μm in and about 10 mm to about 100 μm in depth. The volume of a mini-well is generally small, and may range from about 0.001 μl to about 100 μl. Such sample receiving locations may have means for receiving any number of samples, such as 96, 384, or 1536 samples. In some embodiments of the invention, the sample receiving location may be preloaded with a substance, chemical or reagent. For example, a reagent may interact with a sample after the sample is dispensed to the sample receiving location. In some embodiments, different reagents may be applied to different parts of the sample receiving location.

As the format of the samples from the sample source and the sample receiving locations may differ, transferring the samples from the sample source to the sample receiving source may result in reformatting of the samples. Such reformatting may result in a change in the size or shape of the area occupied by the samples. For example, sample from a standard 96 multi-well plate may be delivered to a microchip which may receive 96 nano-quantities of sample. Reformatting may result in a change of the number of samples. For example, samples drawn from 384 wells may be combined during transfer and delivered to a sample receiving location with 96 wells. Also, the sample capacity volumes of the sample receiving locations may vary. For instance, if a sample source has a greater sample volume capacity, reformatting may only transfer a portion of the sample from the sample tot he sample receiving location.

The dispenser may comprise a plurality of capillary channels which may be capable of receiving a sample from a sample source and dispensing the sample to a sample receiving location. The dispenser may be capable of reformatting the sample to accommodate the sample source and sample receiving location, and the capillary channels may be arranged accordingly.

A capillary channel may include a passage for a sample with at least one first end and at least one second end such that the first end and second end are open. In a preferable embodiment of the invention, a capillary channel may have one first end and one second end. The cross-sectional area of a capillary channel may be such that a sample may rise within the capillary channel through capillary action (without the need for an externally applied force) when the capillary channel contacts the sample in a substantially vertical orientation. The shape of the cross-section of a capillary channel may vary. For example, the cross-section of a capillary channel may be circular. The cross-section of a capillary may also be an oval or a rectangle, or any other shape such that the capillary channel is capable of drawing up a sample through capillary action.

A capillary channel may be formed of any material that is capable of containing the sample. For instance, the capillary channel may be formed by a glass, plastic, or some form of polymer. Some examples of materials that may form capillary channels include, but are not limited to, glass, fiberglass, silicon, ceramic, carbon fiber, metals, or polymers such as acrylic, acrylonitrile butadiene styrene, polyetherimide, acetal copolymer, heat stabilized polypropylene, polyethersulfone, polyarylethersulfone, polysulfone, polyphenylene oxide & styrene, polycarbonate, ultra high molecular weight polyethylene, polyetheretherketone, polyphenylene sulfide, or polystyrene.

Capillary channels may be formed of hydrophobic or hydrophilic materials. For instance, a capillary channel may have a hydrophilic interior due to the presence of a hydrophilic material, such as a fused silica, or coatings such as poly(vinylpyrrolidone), poly(vinyl alcohol) cross-linked with glutaraldehyde, silicone dioxide, acrylic with oligomeric analogs of monomethoxy polyethylene glycol grafted on, or coatings used in the manufacture of medical devices or capillary electrophoresis devices. In another example, a capillary channel may have a hydrophobic interior due to the presence of hydrophobic material such as polyvinylchloride, polyetheretherketone, silicone or polytetrafluoroethylene, or a coating, such as parylene.

In some embodiments of the invention, all of the capillary channels within a dispenser may have hydrophobic surfaces, or all of the capillary channels within the dispenser may have hydrophilic surfaces. In other embodiments of the invention, one or more of the capillary channels within a dispenser may have hydrophobic surfaces while one or more of the capillary channels may have hydrophilic surfaces.

In accordance within some embodiments of the invention, the capillary channels may be preloaded with a reagent. For example, a reagent may be applied to the inner surface of the capillary channel, which may interact with a sample when a sample is drawn into the capillary channel.

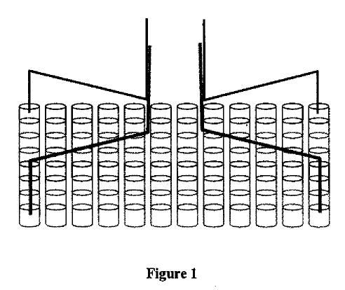

FIG. 1 shows several exemplary capillaries applied to sample wells. In one embodiment of the invention, capillary channels may be formed from capillary tubes. The capillary channels may be capable of contacting the sample from the sample source. For example, a capillary tube may be able to go within a well to receive a sample within the well.

The dispenser may be able to receive the sample through capillary action. For example, the first end of a capillary channel may contact a sample, and the sample may be draw into the capillary channel through the influence of natural processes such as capillary action or gravity, as opposed to an outside, unnatural force. Alternatively, the first end of a capillary channel may contact a sample, and the sample may be draw into the capillary channel by means of an outside force. Such an outside force may be exerted by mechanical means, for example, applying a negative pressure to the capillary channel.

In a preferable embodiment of the invention, a predetermined volume of sample may be draw into the capillary channel by means of capillary action. The sample may fill the capillary channel, in which case the predetermined volume of sample may be the volume enclosed within the capillary channel.

The volumes of the capillary channels within the dispenser may be the same. For example, the volume of each capillary channel may be 1 nL, 5 nL, 10 nL, 20 nL, 50 nL, 75 nL, 100 nL, 150 nL, 200 nL, 500 nL, 1 μL, 10 μL, 100 μL, 1000 μL. Contacting the dispenser to the samples may cause the same predetermined volume of sample to be drawn up into each capillary channel. For instance, if each capillary channel has a volume of 100 nL, each capillary channel may draw up 100 nL of sample.

Alternatively, the capillary channels within the dispenser may have different volumes. For example, within one dispenser, some of the capillary channels may have volumes of 90 nL, while some of the capillary channels may have volumes of 100 nL, and some of the capillary channels may have volumes of 110 nL. Such differences may be desirable in situations where the sample receiving location may be adapted to receive different quantities of samples. The predetermined volume of sample drawn into the capillary channels may vary with the volumes enclosed within the capillary channels.

FIG. 1 shows four exemplary capillary channels contacting a sample source comprising sample wells. In one embodiment of the invention, the number of capillary channels may be the same as the number of wells. For example, if the sample source is a 384 microtiter plate, there may be 384 capillaries that can be oriented to contact each of the sample wells. In another embodiment of the invention, the number of capillary channels may be the same as the number of receiving locations on the sample receiving location. For example, if the sample receiving location is a microchip with 384 mini-wells, there may be 384 capillaries that can be oriented to contact each of the mini-wells. In a preferable embodiment of the invention, the number of wells and the number of mini-wells may be the same. For example, a dispenser may include n capillary channels, which may contact n wells of an n-well plate of a sample source, and may dispense a sample to a microchip with n mini-wells, where n is any integer greater than 1.

In an alternate embodiment of the invention, the number of wells and the number of mini-wells may differ. In such a situation, the number of capillaries, each with one first end and one second end, may be the same as the number of source wells, and the second ends of the capillaries may be oriented so that the capillaries may dispense to some or all of the mini-wells. Alternatively, the number of capillaries, each with one first end and one second end, may be the same as the number of mini-wells, and the first ends of the capillaries may be oriented so that the capillaries may receive samples from some or all of the source wells. In yet another implementation, the capillaries may have one or more first end and one or more second end, such that the number of the first ends of the capillaries is the same as the number of source wells and the number of second ends of the capillaries is the same as the number of mini-wells. For instance, if a sample source comprises 16 source wells, and a sample receiving location comprises 32 mini-wells, each capillary channel may have one first end, and may branch off into two second ends.

In another embodiment of the invention, the number of capillary channels may be different from the number of wells. For instance, if the sample source comprises 96 source wells, there may be four capillary channels.

The capillary channels may be arranged so that they may contact the samples at substantially the same time. For example, if the sample source contains 96 wells in a rectangular array and arranged in a planar fashion, the first ends of the capillary channels may be arranged so that they form a planar grid spaced to come into contact with the interior wells of the sample source. The capillary channels may contact the samples and draw them up at the same time, for example, the 96 samples may be drawn into the dispenser simultaneously. The first ends of the capillary channels may not have a planar arrangement, preferably if the sample source does not have a planar arrangement. For example, some sample wells may be placed lower than some others, in which case, the first ends of some of the capillaries may protrude further than some of the other capillaries. In another example, the first ends may not have a planar arrangement while the sample wells may be planar, which may result in the first ends contacting the samples at different times as the capillary channels or sample source may move relative to one another.

The capillary channels may also be arranged so that the second ends may be oriented to dispense the samples to the sample receiving location. For example, if the sample receiving location is a microchip with 96 mini-wells, the second ends of the capillary channels may be oriented to dispense the proper samples to the proper mini-wells. The second ends of the capillary channels may or may not be coplanar.

In one embodiment of the invention, the first ends of the capillary channels and the second ends of the capillary channels of the dispenser may be substantially parallel to one another. The first ends and the second ends may be pointed in opposite directions from one another.

As discussed previously, the first footprint area of the sample source may be different from the second footprint area of the sample receiving location. The footprints of the first ends and the second ends of the capillary channels may also be different. For instance, the footprint area of the first ends of the capillary channels may correspond to the footprint area of the sample source, and the footprint area of the second ends of the capillary channels may correspond to the footprint area of the sample receiving location. FIG. 1 shows an example of capillary channels where the footprint of the first ends of the capillary channels are greater than the foot print of the second ends of the capillary channels. In such a situation, the second ends of the capillary channels may be spaced more closely together than the first ends of the capillary channels.

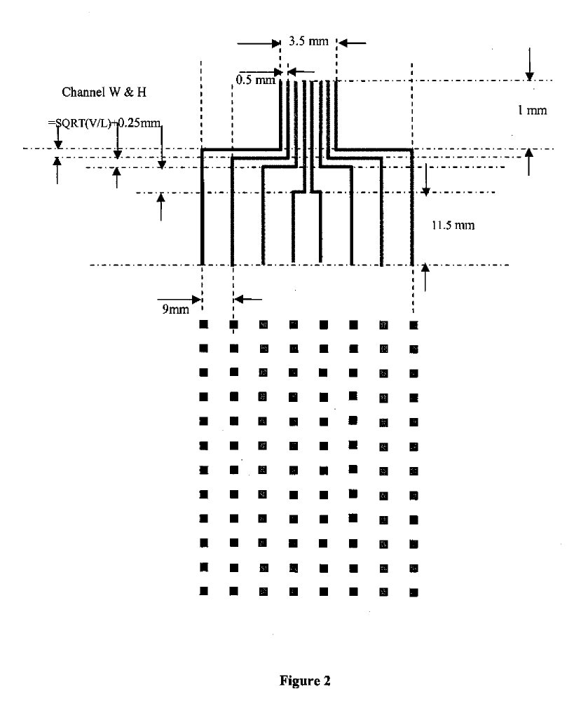

FIG. 2 shows a profile of several exemplary capillary channels as well as a cross-sectional view of the sample source that the capillary channels may contact. For instance, the sample source may comprise a 96 microtiter plate with 96 sample wells as shown. Such sample wells may be spaced 9 mm apart. The capillary channels may be arranged so that they can contact the samples, and may also be spaced so that their first ends are 9 mm apart. Also, the sample receiving location may include a microchip where the mini-wells are spaced 0.5 mm apart. The capillary channels may be correspondingly arranged so that the samples may be dispensed to the proper mini-wells, so that their second ends are 0.5 mm apart.

The capillary channels may be arranged in any manner between the first ends and the second ends. For example, the channels may be arranged as shown in FIG. 2 so that the channels may not overlap. In another example, the channels may have an orthogonal path where they may travel vertically or horizontally relative to the dispenser orientation. Alternatively, the capillary channels can travel in any manner, such as by curving around.

The capillary channels may be arranged and oriented using one or more support structure. The support structure may determine that the first ends and the second ends of the capillary channels are spaced and oriented properly.

In one embodiment of the invention, the capillary channels may be embedded within the dispenser. For example, the dispenser may comprise a block or other shape through which capillary channels may run (not dissimilar to tunnels). The block or shape may form a support structure for the internal capillary channels. In some embodiments of the invention, the block or shape may be solid except for the capillary channels within. In other embodiments of the invention, the block or shape may have an internal structure which may lend support to the capillary channels. For example, the block or shape may be porous besides the capillary channels within.

Capillary channels or support structures may be fabricated using techniques known or later developed in the art, such as any form of lithography; UV polymerization lithography; micro injection molding; hot embossing; etching, graytone lithography; x-ray lithography; laser microfabrication, etching techniques such as wet chemical, dry, and photoresist removal; screen printing; lamination; low pressure vapor deposition; or other rapid prototyping techniques. See generally Rai-Choudhury, ed., Handbook of Microlithography, Micromachining & Microfabrication (SPIE Optical Engineering Press, Bellingham, Wash. 1997); U.S. Pat. No. 7,168,939; Berins, ed., Plastics Engineering Handbook of the Society of the Plastics Industry, Inc. 5th ed. (Van Nostrand Reinhold, NY. 1991); U.S. Pat. No. 6,267,5 80; Madou, Fundamentals of Microfabrication (CRC-Press 1998). Capillary channels or support structures may also be fabricated through machining or casting. Any of the various fabrication techniques may be combined in the fabrication of the capillary channels or support structures.

A support structure may be fabricated by combining layers that may have been fabricated using any methods described or known in the art. For example, a feature that may be internal to the support structure, such as a capillary channel, can be machined in complementary halves on layers such as polymer sheets and the complementary polymer sheets can then be layered. In another example, a capillary channel may be machined as a slit or hole in a layer, to be discussed further. Layers can be combined, for example, by bonding with diffusion bonding, thermal bonding, ultrasonic welding or an adhesive, clamp, pin, screw or other fastening device.

In another embodiment of the invention capillary channels may be formed from capillary tubes. In some embodiments of the invention, the tubes may be relatively rigid. In other embodiments of the invention, the tubes may be flexible and bendable. The support structures may be arranged about the capillary tubes so that the first and second ends of the capillary channels are spaced and oriented properly. For example, the support structure may have a flexible member to hold the capillary tubes in place, or capillary tubes may be attached to a support structure using more permanent means, such as glue, adhesive, melting or bonding.

Besides orienting capillary channels, support structures may have other properties to be considered. For instance, the shape of a support structure may be considered, such as whether it has a flat surface or is compact. A material for the support structure may also depend on whether the support structure is resistant to compression, whether it has a low thermal expansion coefficient, whether it has the ability to transmit, reflect or absorb desired wavelengths of light, whether it is resistant to particular chemicals, such as solvent, alcohol, hydrocarbon, nitrile, and so forth.

Support structures may be made from any material capable of orienting the capillary channels properly. The material may have sufficient structural properties to control capillary channel paths. In some instances, the support structure materials may form the walls of the capillary channels (such as an embodiment where the capillary channels may be embedded within a solid support structure). The support structure materials may include any materials that may be used for the capillary channels, such as various glasses, plastics, metals, or polymers.

In some embodiments of the invention, the capillary channels may extend beyond a support structure. For example, a support structure may comprise a solid block with channels within, but the channels may have portions that protrude from the block. For example, the protrusions may be tube-like structures coming out of the block, and may provide continuations for the capillary channels and enable the channels to within a sample well. In another example, if the capillary channels are formed from capillary tubes, the tubes may extend beyond the support structure. The extensions of capillary channels may be at the first ends of the capillary channels, the second ends of the capillary channels, or both ends.

Protruding portions of a support structure, such as protruding tips for capillary channels can be fabricated as part of the support structure or may be attached to a support structure with any of the techniques described or known in the art.

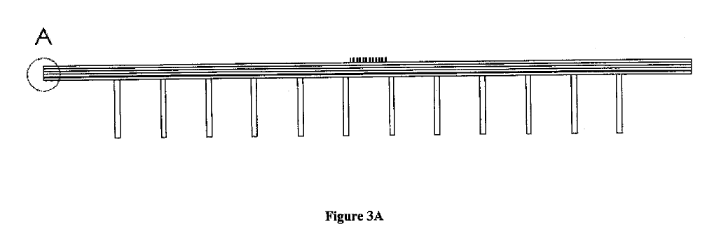

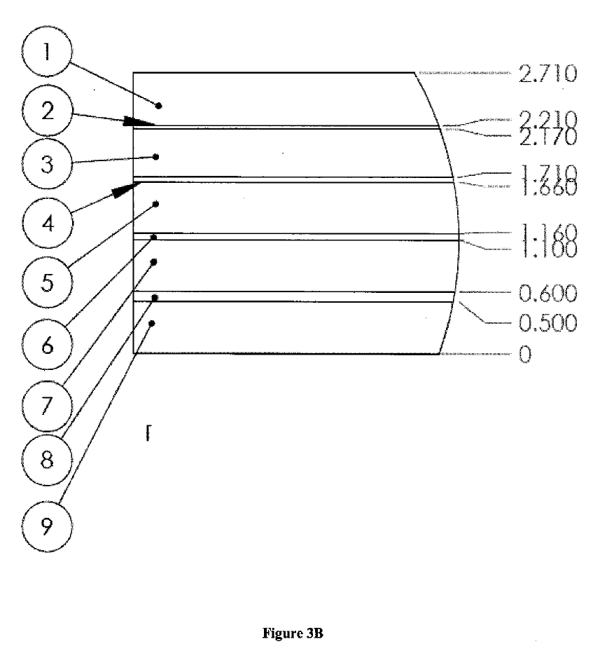

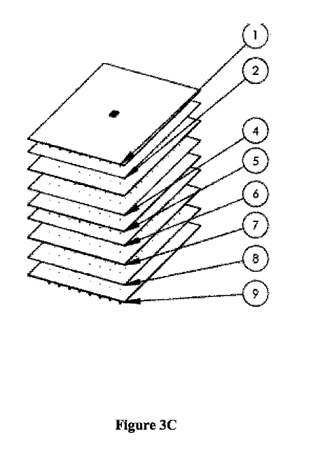

FIG. 3A shows a side view of a support structure and a plurality of capillary channels in accordance with one embodiment of the invention. The support structure may be made of a series of layers, wherein the layers may form masks, which may form the capillary channels within the support structures. The dispenser may include protruding portions of the first ends of the capillary channels, which may be formed of tube-like structure, and protruding portions of the second ends of the capillary channels, which may be formed of a tube-like structure. The protruding portions may have any shape or size. In one example, the protruding portions of the first ends of the capillary channels may have a greater footprint than the protruding portions of the second ends of the capillary channels. The capillary channels may reach through the layered support structure between the first and second ends.

FIG. 3B shows a close-up of a side of the support structure with a plurality of capillary channels. In one embodiment of the invention, the layers may have different thicknesses. For example, the layers may have greater thicknesses where the masks of the layer provide for only vertical portions of the capillary channels, and the layers may have lesser thicknesses where the masks of the layer provide for horizontal portions of one or more of the capillary channels. The thickness of the layers that may provide for horizontal portions of one or more capillary channels may depend on the desired volume and cross-sectional area of a capillary channel. Alternatively, the layer thicknesses may all be the same.

FIG. 3C shows an exploded view of the layers making up the support structure and plurality of capillary channels. The layers may include open portions that may look like holes, that may form the vertical portion of the capillary channels and open portions that may look like lines that may form the horizontal portions of the capillary channels. The layers may be aligned so that the vertical and horizontal portions of the capillary channels may line up to form continuous capillary channels.

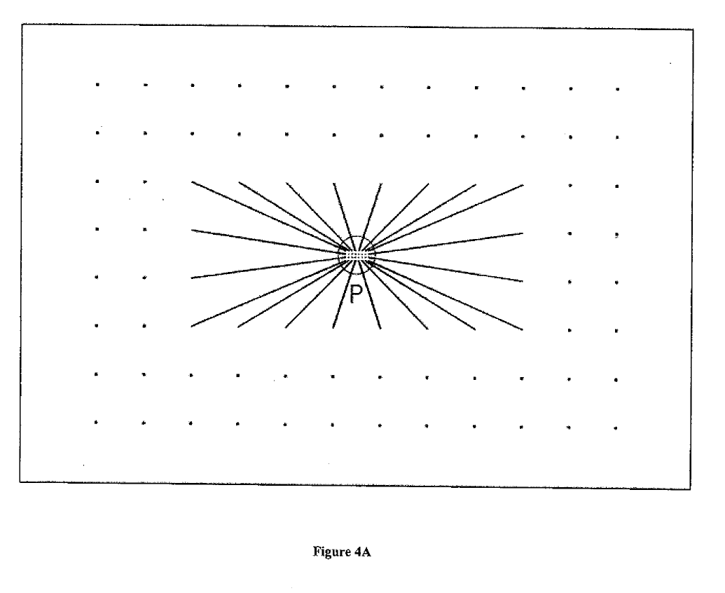

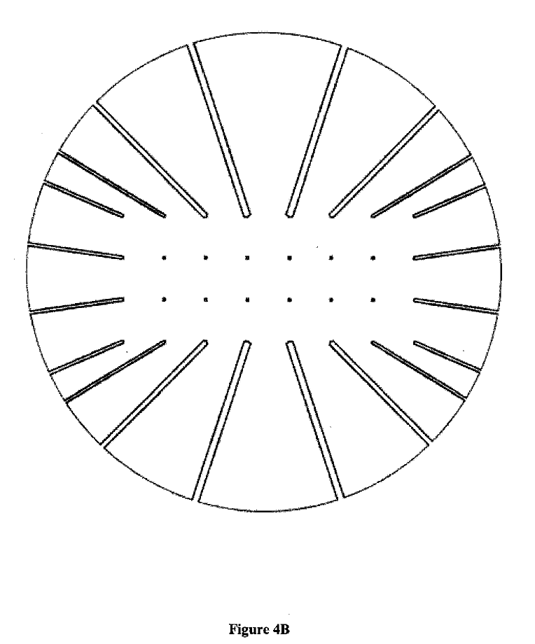

FIG. 4A shows an exemplary layer of the support structure and plurality of capillary channels. The exemplary layer may include open portions that look like holes which may form the vertical portions of the capillary channels and open portions that look like lines that may form the horizontal portions of the capillary channels.

FIG. 4B shows a close-up of the layer of the support structure and plurality of capillary channels. The lines within the layer forming the horizontal portions of the capillary channels may have different thicknesses and/or length.

In one embodiment of the invention, the volume of each of the capillary channels may be the same. For instance, each capillary channel in a dispenser may draw a predetermined volume of sample, where the predetermine volume is the same for each capillary channel. The volume of each of the capillary channels may be affected by the length of the capillary channels and the cross-sectional area of the capillary channel. The length and path of the capillary channels may be chosen in accordance with factors such as the fluid properties of the sample, the desired rate of sample transfer, locations of the first ends and the second ends. In one implementation, the length of the capillary channels may be different due to the reformatting from the sample source to the sample receiving location. In such an implementation, the cross-sectional area of the capillary channel may be varied to compensate for the difference in the lengths of the capillary channels. For example, a capillary channel with a greater length may have a smaller cross sectional area to retain the same volume as a capillary channel with a shorter length and larger cross-sectional area.

In another implementation, the length of the capillary channels may remain the same. Uniform lengths of capillary channels may be useful in applications where substantially simultaneous receipt of samples may be desired. By maintaining a uniform length of capillary channels, the cross-sectional areas of the capillary channels may be uniform. Even if a first capillary channel has a shorter distance to travel between its first end and second end, than a second capillary channel, the first capillary channel may be made to have the same length as the second capillary channel by twining the capillary channel path so that they have the same length.

For example, in one embodiment of the invention where the capillary channels may have a cylindrical shape, the volume within a capillary channel may be described as π*r²*L where r is the radius of the capillary channel and L is the length of the capillary channel. For example, if L is varied, then r may be varied in order to maintain the same volume. For example if there are two capillary channels where the first capillary channel has a volume V₁=πc*r₁²*L₁, and the second capillary channel has a volume V₂=π*r₂²*L₂, for V₁=V₂, π*r₁²*L₁=π*r₂²*L₂, which leads to L₁=(r₂/r₁)²*L₂ being the relationship between the lengths of the capillary channels and the radii.

The cross-sectional area of a capillary channel may be selected based on the length of the capillary channel. Alternatively, the cross-sectional area may be selected based on the desired rate of fluid transfer under the conditions of use. The cross-sectional area of the capillary channel may be of a sufficient size to allow the sample to move within by capillary action. For example, the cross-sectional area of the capillary tube may be about 10, 5, 1, 0.5, 0.2, 0.1 0.05, 0.01, 0.001, 0.0001 mm². The cross-sectional shape, area, or both of a capillary channel may be substantially uniform over the length of the channel. In alternative embodiments, the shape, area, or both of the channel may vary along its length.

Similarly, the cross-sectional shape, area, or both of a capillary channel may be substantially uniform over its entire length including the portions of the channel that may protrude from the support structure. In alternative embodiments, the cross-sectional shape, area, or both may vary along the length of a capillary channel, such as the portion of the channel that may protrude from the support structure. For example, the second end of a capillary channel may form a nozzle shape so that the cross-sectional area may be smaller at the second end, and allow a more controlled stream of sample to be dispensed.

In some embodiments of the invention, the entire predetermined volume within each of the capillary channels may be dispensed to the sample receiving location. For example, a capillary channel may have an enclosed volume of 100 nL, and may receive a sample from a sample source such that the entire volume of the capillary channel is filled with the sample, meaning the capillary channel may be holding 100 nL of sample. The entire 100 nL of sample may be dispensed to the sample receiving location. In such an implementation, there may be no dead volume within a capillary channel, since the totality of the sample within the channel may be removed. Not having a dead volume within a capillary channel may advantageously minimize carryover contamination. Filling an entire capillary channel and not having any dead volume may also allow for greater accuracy of sample volume dispensed.

In alternative embodiments of the invention, the entire quantity of sample within a capillary channel may not be dispensed to a sample receiving location. Only a part of the sample within the capillary channel may be dispensed to a sample receiving location at one dispensing step.

In accordance with one embodiment of the invention, the capillary channels and the sample receiving location may remain substantially stationary while the sample is dispensed to the sample receiving location. For example, if 100 nL are being dispensed from each of the capillary channels, the capillary channels and the sample receiving location (such as a microchip) may be substantially stationary while the entirety of the 100 nL sample is being dispensed into the microchip. The distance of the second ends of the capillary channels from the sample receiving location may be any distance sufficient to allow the entire sample volume to be dispensed to the sample receiving location without having to move either the capillary channels or the sample receiving location.

Some embodiments of the invention may provide for applying an outside force to the dispenser to dispense the sample to the sample receiving location. Such outside forces may include mechanical means such as applying negative or positive pressure to the sample within the capillary channels. In one implementation, a positive pressure may be applied to the capillary channels with the samples disposed therein from the first ends of the capillary channels.

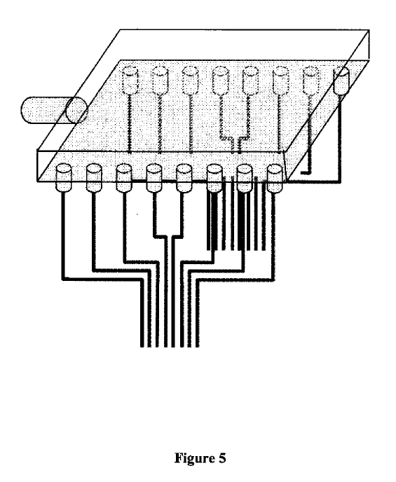

FIG. 5 shows several exemplary capillary tubes connected to an air pressure chamber. The air pressure chamber may operably connect to the first ends of the capillary channels and may exert a positive pressure that may cause the samples within the capillary channels to be dispensed through the second ends of the capillary channels. The positive pressure may be any amount of pressure that is sufficient to force the samples from the capillary channels. For instance, an air pressure chamber may exert a pressure of 1.1 atm, 1.5 atm, 2.0 atm, 2.5 atm, 3.0 atm, 4.0 atm, 5.0 atm, 10 atm, or 15.0 atm. The air pressure chamber may make contact with the first ends of the capillary channels after the sample has been received from the sample source.

The air pressure chamber may have various means for making contact with each of the first ends of the capillary channels. For example, the air pressure chamber may have openings that may each connect one of the capillary channels. In another example, the air pressure chamber may have one large opening that may cover all of the capillary channels and be flush to the support structure so that sufficient pressure may be exerted on the capillary channels.

In alternate embodiments of the invention, a positive pressure may be exerted on the capillary channels through the user of a pump or syringe. Also, in addition to air, other gases may be used to pressurize a sample. Several examples of gases may include argon, nitrogen, helium, or any inert gas.

In some embodiments of the invention, there may be no evaporation of the sample during the dispensing process. To prevent evaporation of aqueous samples, the samples can be applied to the sample receiving location at or around dew point. Dew point may refer to a temperature range where the droplet size does not change significantly. At dew point, an equilibrium may be reached between the rate of evaporation of water from a sample droplet and the rate of condensation of water onto the droplet from the moist air overlying the sample receiving location. When this equilibrium is realized, the air is said to be saturated with respect to the planar surface of the sample receiving location. At one atmospheric pressure, the dew point is about 14° C. Accordingly, dispensing aqueous samples may be carried out at a temperature no more than about 1° C. to about 5° C. degrees above dew point. As is apparent to one skilled in the art, dew point temperature increases as the external pressure increases. Therefore, where desired, one may dispense the samples in a pressured environment to prevent evaporation.

In one embodiment of the invention, the capillary channels may receive a sample from a sample source while in a substantially upright position. Alternatively, the capillary channels may receive a sample from a sample location while the first ends are directed in any orientation.

In accordance with another embodiment of the invention, the dispenser may be rotated to a sufficient degree to allow the positive pressure to be exerted on the capillary channels and the sample to be dispensed to the proper sample receiving location. For example, the first ends and the second ends of the capillary channels may be pointed in opposite directions. The dispenser may be flipped about 180 degrees so that the second ends of the capillary channels may face the direction that the first ends of the capillary channels were facing. If the first ends of the capillary channels were initially facing downwards to receive the sample, the dispenser may be flipped so that the second ends of the capillary channels may be facing downwards.

In an alternate example, the first ends and the second ends of the capillary channels may be pointed in directions that are not opposite one another. For instance, the first ends of the capillary channels may initially be pointing downwards while the second ends of the capillary channels may be initially pointing horizontally, at 90 degrees to the first ends. The dispenser may be flipped about 90 degrees so that the second ends of the capillary channels may be facing downwards and the first ends of the capillary channels may be facing horizontally.

Regardless of initial orientation of the capillary channels, and the orientations of the first and second ends of the capillary channels, the dispenser may be rotated to whatever degree will allow the positive pressure to be exerted on the capillary channels and allow the sample to be dispensed to the proper sample receiving location.

The positive pressure source may connect to the first ends of the capillary channels after the dispenser has been rotated to the appropriate orientation. For example, an air pressure chamber may operably connect to the first ends of the capillary chamber after the rotation.

In an alternate embodiment of the invention, the dispenser may not rotate. For example, if the dispenser starts with the first ends of the capillary channels pointed downwards, the air pressure chamber may be moved so that it is beneath the dispenser connects to the first ends of the capillary channels. Alternatively, the dispenser may be moved without rotating it so that it may connect to the air pressure chamber.

The sample may be dispensed to the sample receiving location. In one embodiment of the invention, the second ends of the capillary channels may be oriented downwards to dispense the sample to the sample receiving location. In alternate embodiments of the invention, the second ends of the capillary channels may have any orientation that may enable them to dispense the sample to the sample receiving location. For example, in some embodiments, the capillary channels may dispense a liquid to a sample receiving location horizontally at 90 degrees.

The invention provides for a method of transferring a plurality of samples from a sample source to a sample receiving location in accordance with another aspect of the invention. The dispenser may receive a sample from a sample source through the first ends of a plurality of capillary channels. The dispenser may dispense the sample through the second ends of the capillary channels to a sample receiving location. In one embodiment of the invention, the capillaries may receive the sample by contacting the sample source and drawing a predetermined volume of sample through the first ends of the capillary channels using capillary action. Then, a positive pressure may be applied to the first ends of the capillary channels, which may result in dispensing a sample through the second end of each of the plurality of separate capillary channels to a sample receiving location. In some embodiments, applying positive pressure to the first ends of the capillary channels may result in dispensing the entire quantity of sample drawn through the first ends of the capillary channels through the second ends of the capillary channels. Dispensing the entire sample may result in no dead volume remaining in a capillary channel.

In a preferable embodiment of the invention, a sample source, such as a multi-well plate may be disposed beneath the dispenser. The dispenser may comprise a plurality of capillary channels, each with a first end and second end, such that the first and second ends are oriented in opposite directions. The capillary channels may all have the same volume. The first end of each capillary channel may contact the sample of each well of the multi-well plate. The sample may be drawn up through capillary action. The sample may fill the entire volume of each of the capillary channels. The dispenser may be flipped approximately 180 degrees so that the second ends of the capillary channels may be oriented downwards. A sample receiving location may be oriented below the dispenser. The first ends of the capillary channels of the dispenser may be operably connected to an air pressure chamber, which may exert a positive pressure. The entire sample volume may be dispensed to a sample receiving location, such as a micro-chip.

The invention may be able to transfer and dispense many samples simultaneously and relatively quickly. For example, the invention may be able to transfer and dispense 96, 384, or 1536 samples simultaneously. In another example, the invention may be able to dispense the entire sample within a capillary tube within 0.1 seconds, 0.5 seconds, 1 second, 2 second, 3.5 seconds, 4.0 seconds, 5.0 seconds, 10.0 seconds, 30 seconds, 1 minute after the dispenser is properly oriented and connected to the pressure source.

In some embodiments of the invention, the sample source may have a greater volume of sample than the volume dispensed by the dispenser. In some implementations, a dispenser may receive samples from the same sample source a plurality of times. For example, if each well of a sample source contains more than 1000 nL, and each capillary channel has a volume of 100 nL, such that 100 nL may be dispensed to the sample receiving location, a dispenser may use the same sample source to dispense to 10 sample receiving locations.

In some alternative embodiments, the sample receiving location may have a greater volume capacity than the sample source or the amount dispensed by the dispenser. In some implementations, a dispenser may receive samples from multiple sources and dispense to the same receiving location.

Another aspect of the invention further provides for a dispensing kit comprising the dispenser comprising an array of capillaries as discussed previously and instructions for use thereof. The kit may include one or more packages including one or more dispenser. The dispensers may be disposable, so that they can be easily replaced after a given amount of use. In some embodiments, dispensers may be individually packaged or may be packaged together.

The kit may also include a device for manipulating the dispenser, such as a device to move the dispenser to contact the sample or to rotate the dispenser to dispense the sample to the sample receiving location. The device to manipulate the dispenser may also include a pressure source, such as an air pressure chamber. The device may include one or more components, which may or may not be included within the kit. Alternatively, the pressure source, such as the air pressure chamber, may be separate from the manipulating device, and may or may not be included in the kit. The kit may also contain any components necessary for the device or pressure source to operate. For example, the kit may include a component to power the manipulating device. The kit may also include a component that allows the pressure source to provide pressure, such as a gas source. The kit may also include a component that may allow a manipulating device to operably connect with a pressure source.

The kit may also include one or more sample sources or one or more sample receiving locations. In some embodiments of the invention, the dispenser may be adaptable to interact with one or more sample sources and one or mores sample receiving locations. The kit may include one type of sample source or sample receiving locations. For example, a kit may contain several 96-well microtiter plates and several microchips with 96 mini-wells. Alternatively, the kit may include a variety of sample sources or sample receiving locations. For example, a kit may come with a 96-well microtiter plate, a 384-well microtiter plate, and a 1536-well microtiter plate.

The kit may be conveniently packaged and may be commercially available. The kit may also include written instructions for use or maintenance of items therein.

A system for liquid handling may include a sample source, a dispenser comprising a plurality of capillary channels with a support structure, a manipulation device, a pressure source, a sample receiving location contacting a temperature block, and an optical detection device in accordance with an aspect of the invention. The dispenser, including a plurality of capillary channels with first ends and second ends, may transfer a sample from the sample source to the sample receiving location. The first ends of the capillaries may draw a predetermined volume of sample from the sample source through capillary action.

The dispenser may be manipulated by the manipulating device to get the dispenser into the proper orientations to receive the samples and dispense the samples. Alternatively, the manipulation device may allow the dispenser to remain stationary while other components move. For example, a dispenser may be loaded and the sample source may be moved to contact the dispenser, and the pressure source and the same receiving locations may be moved to the proper locations and orientations to cause the sample to be dispensed to the sample receiving location.

The pressure source may connect to the dispenser and exert a pressure through the first ends of the capillary channels to dispense the sample through the second ends to the sample receiving location. In some embodiments of the invention, the sample receiving locations may be sealed upon receiving the sample. For instance, the well may be sealed by (a) applying a radiation-curable adhesive along peripheral dimensions defining an open surface of the micro well; (b) placing a cover to encompass the peripheral dimensions that define the open surface of the micro well; and (c) exposing the micro well to a radiation beam to effect the sealing. A wide range of radiation curable adhesive may be applicable for the present invention. They include but are not limited to a diversity of acrylics, acrylates, polyurethanes (PUR), polyesters, vinyl, vinyl esters, and epoxies that are curable by radiation beams such as UV radiation and other radiation beams of various frequencies.

The sample receiving location may be operably linked to a temperature block that may affect the temperature at the sample receiving location. The temperature block may be in thermal contact with the sample receiving location. In one embodiment of the invention, the temperature block may be a heating element, where varying and/or maintaining of temperature may be achieved by controlling the heating element. In some embodiments of the invention, the temperature block may include more than one thermo-controllable units, so that different portions of the sample receiving location may be separately controlled and may be at different temperatures. In some embodiments of the invention, the temperatures from the temperature blocks may cycle.

In some embodiments of the invention the temperature block may contact the sample receiving location on the upper or bottom surface. For example, the sample receiving location may be resting on top of a temperature block when the sample is dispensed. In another example, a temperature block may come into contact with the top of a sample receiving location after a sample has been dispensed.

An optical detection device may be positioned so as to be directed to the sample receiving location. The optical detection system may be able to detect optical signals emitted from a reaction sample. The optical detection system may be fabricated with photon-sensing elements in optical communication with the sample receiving location where chemical reactions may be taking place. Representative photon-sensing elements include photo multiplier tube, charge coupled device, avalanche photo diode, gate sensitive FET's and nano-tube FET's, and P-I-N diode.

In some embodiments, the optical system may monitor an optical signal over a multiple-cycle period, as the temperature block may have cycling temperatures. In another embodiment, the optical system may detect an optical signal that is proportional to the amount of product of the chemical reaction taking place in the micro well over a multiple-cycle period. The optical system can include a spectrum analyzer that may be composed of an optical transmission element and a photon-sensing element. Preferred optical transmission element can be selected from the group consisting of multi-mode fibers (MMF), single-mode fibers (SMF) and a waveguide. Preferred photon-sensing element can be selected from the group consisting of photo multiplier tube, charge coupled device, avalanche photo diode, gate sensitive FET's and nano-tube FET's, and P-I-N diode.

Such a system for reformatting a sample and delivering a sample to a sample receiving location may be used for biological testing, such as performing PCR and other reactions. The apparatus of the invention may be capable of performing a vast diversity of chemical reactions, such as enzymatic reactions, including but not limited to nucleic acid amplification reaction that encompasses PCR, quantitative polymerase chain reaction (qPCR), nucleic acid sequencing, ligase chain polymerase chain reaction (LCR-PCR), reverse transcription PCR reaction (RT-PCR), reverse transcription, and nucleic acid ligation.

The invention also provides a method of delivering a sample to a sample receiving location such as a microchip and optical system described herein to detect the presence or absence of a target nucleic acid in a plurality of reaction samples. In certain aspects, the amplified target nucleic acids are observed by transmitting excitation beams into dispensed samples, and detecting the optical signals coming from the samples. In other aspects, formation of amplified target nucleic acids is observed by transmitting excitation beams into the reaction samples at a plurality of times during the amplification, and monitoring the optical signals coming from the micro well at each of the plurality of times.

### EXAMPLES

In one example, the capillary channels may all have the same volume. The following design criteria may apply.

Exemplary Design 1: Keeping Channel Lengths same for all 96 or 384 or 1536 Microchannels
Flow rate (mL/min)=F
Radius/square side/rectangular L/W(μm)=r=SQRT(F/L/π)
Time to dispense(sec)=t=F/Well Volume
Total pressure drop in micro channel (psi)=ΔP
Viscosity (cp)=\acute{η}
Micro channel Length (cm)=L
Flow rate (mL/min)=(r⁴*ΔP)/(\acute{η}*L)*1.625*10⁻⁸

Exemplary Design 2: Keeping Each Channel Lengths Minimum for all 96 or 384 or 1536 Micro Channels
Flow rate (mL/min)=Fₙ
Radius/square side/rectangular L/W(μm)=rₙ
Total pressure drop in micro channel (psi)=ΔPₙ
Viscosity (cp)=\acute{η}
Micro channel Length (cm)=Lₙ
Flow rate (mL/min)=(rₙ⁴*ΔPₙ)/(\acute{η}*Lₙ)*1.625*10⁻⁸

In accordance with one or more exemplary design, one possible set of results may be:

Volume 0.1 μL

| F | r | ΔP | n | L | t |
|---|---|---|---|---|---|
| (nL/min) | (μm) | (psi) | (cp) | (cm) | (sec) |
| 1712 | 13.12831209 | 30 | 1 | 8.461102551 | 3.5 |

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

1. A dispenser comprising:
(a) an array of capillaries for transfer of aqueous samples, said array comprising:
a plurality of separate capillary channels each comprising a first end and a second end, wherein the first end is adapted to draw a predetermined volume of sample from a sample source; and
a pressure source capable of operably connecting to the first ends of the plurality of separate capillary channels wherein the pressure source may effect a transfer of the predetermined volume of sample entirely from the first end to the second end; and
(b) a support structure orienting the first end as a first footprint and orienting the second end as a second footprint, wherein the first footprint and second footprint have a different area.

2. The dispenser of claim 1 wherein the sample source is a multi-well plate comprising a plurality of source wells.

3. The dispenser of claim 1 wherein the sample source is at least one of: a 96, 384 or 1536 microtiter plate.

4. The dispenser of claim 1 wherein the sample source is a microtiter plate for holding polymerase chain reaction (PCR) samples.

5. The dispenser of claim 1 wherein the plurality of separate capillary channels comprises at least one of: 96 capillary channels, 384 capillary channels, or 1536 capillary channels.

6. The dispenser of claim 1 wherein the plurality of separate capillary channels includes a plurality of separate capillary tubes.

7. The dispenser of claim 6 wherein the plurality of separate capillary tubes is made of glass, plastic, or a polymer.

8. The dispenser of claim 1 wherein the plurality of separate capillary channels is fabricated using at least one of the following methods: UV polymerization lithography, micro injection molding, hot embossing, graytone lithography or x-ray lithography.

9. The dispenser of claim 1 wherein at least one of the plurality of separate capillary channels comprises one or more preloaded reagents.

10. The dispenser of claim 1 wherein the predetermined volume of sample is up to 100 nL

11. The dispenser of claim 1 wherein the first footprint has a greater area than the second footprint.

12. The dispenser of claim 1 wherein the first end is adapted to draw the predetermined volume of sample from the sample source using capillary action.

13. The dispenser of claim 1 wherein the pressure source is a positive pressure chamber.

14. The dispenser of claim 13 wherein the positive pressure chamber exerts a positive pressure greater than 3 atm into the plurality of separate capillary channels.

15. The dispenser of claim 1 wherein the second ends are directed to one or more sample receiving location.

16. The dispenser of claim 1 wherein the sample receiving location is a microchip or microarray.

17. The dispenser of claim 1 wherein the plurality of capillary channels is capable of dispensing a hydrophilic liquid sample and hydrophobic liquid sample at the same time.

18. A dispensing kit comprising the array of capillaries of claim 1 and instructions for use thereof.

19. A method of transferring of aqueous samples, comprising:
receiving a sample from a sample source to a plurality of separate capillary channels each comprising a first end and a second end;
drawing a predetermined volume of sample through the first end of each of the plurality of separate capillary channels using capillary action;
applying positive pressure to the first end of each of the plurality of separate capillary channels;
dispensing the entire predetermined volume of sample through the second end of each of the plurality of separate capillary channels to a sample receiving location.

20. The method of claim 19 further comprising flipping the plurality of separate capillary channels to a degree sufficient for applying positive pressure to the first ends.

21. The method of claim 19 wherein the predetermined volume of sample drawn through the first end of each of the plurality of separate capillary channels is the substantially same volume.

22. A dispenser comprising:
(a) an array of capillaries for transfer of aqueous samples, said array comprising: a plurality of separate capillary channels each comprising a first end and a second end; and
(b) a support structure orienting the first end as a first footprint and orienting the second end as a second footprint,
wherein each of the plurality of separate capillary channels have the substantially same volume capacity,
wherein the first end is adapted to draw the same predetermined volume of sample from a sample source, and
wherein the first footprint and second footprint have a different area.

23. The dispenser of claim 22 wherein each of the plurality of separate capillary channels is effective to transfer the entire predetermined volume of sample from the first end to the second end.

24. The dispenser of claim 22 wherein the sample source is a multi-well plate comprising a plurality of source wells.

25. The dispenser of claim 22 wherein the sample source is at least one of: a 96, 384 or 1536 microtiter plate.

26. The dispenser of claim 22 wherein the sample source is a microtiter plate for holding polymerase chain reaction (PCR) samples.

27. The dispenser of claim 22 wherein the plurality of separate capillary channels comprises at least one of: 96 capillary channels, 384 capillary channels, or 1536 capillary channels.

28. The dispenser of claim 22 wherein the plurality of separate capillary channels includes a plurality of separate capillary tubes.

29. The dispenser of claim 22 wherein the plurality of separate capillary channels is fabricated using at least one of the following methods: UV polymerization lithography, micro injection molding, hot embossing, graytone lithography or x-ray lithography.

30. The dispenser of claim 22 wherein the predetermined volume of sample is up to 100 nL.

31. The dispenser of claim 22 wherein the first footprint has a greater area than the second footprint.

32. The dispenser of claim 22 wherein the first end is adapted to draw the predetermined volume of sample from the sample source using capillary action.

33. The dispenser of claim 23 wherein each of the plurality of separate capillary channels is effective to transfer the entire predetermined volume of sample using positive pressure from the first end.

34. The dispenser of claim 22 wherein the second ends are directed to one or more sample receiving location.

35. The dispenser of claim 22 wherein the sample receiving location is a microchip or microarray.

36. The dispenser of claim 22 wherein the lengths of the plurality of separate capillary channels are substantially the same.

37. The dispenser of claim 22 wherein the lengths of the plurality of separate capillary channels are substantially different.

38. An array of capillaries for transfer of aqueous samples, comprising:
a plurality of separate capillary channels each comprising a first end and a second end; and
a support structure orienting the first ends as a first footprint and orienting the second ends as a second footprint,
wherein the first end is adapted to draw a predetermined volume of sample from a sample source,
wherein the second end is adapted to dispense the predetermined volume of sample to a sample receiving location wherein both the second end and the sample receiving location are adapted to remain substantially stationary during the dispensing, and
wherein the first footprint and second footprint have a different area.

39. A system for dispensing comprising:
a sample source;
an array of capillaries for transfer of a sample from the sample source, the array of capillaries comprising:
a plurality of separate capillary channels each comprising a first end and a second end, wherein the first end is adapted to draw a predetermined volume of sample from the sample source,
a pressure source capable of operably connecting to the first ends of the plurality of separate capillary channels wherein the pressure source may effect a transfer of the predetermined volume of sample entirely from the first end to the second end, and
a support structure orienting the first ends as a first footprint and orienting the second ends as a second footprint, wherein the first footprint and second footprint have a different area;
a sample receiving location for receiving the predetermined volume of sample from the second end, wherein the sample receiving location contacts a temperature block; and
an optical detection device directed to the sample receiving location.

40. The system of claim 39 wherein the sample source is a multi-well plate comprising a plurality of source wells.

41. The system of claim 39 wherein the sample source is at least one of: a 96, 384 or 1536 microtiter plate.

42. The system of claim 39 wherein the sample source is a microtiter plate for holding polymerase chain reaction (PCR) samples.

43. The system of claim 39 wherein the sample receiving location is a microchip or microarray.

44. The system of claim 39 wherein the sample receiving location is used for fluorescent assay.

45. The system of claim 39 wherein the temperature block provides heat to the sample receiving location.

46. A sample transfer block, comprising:
a plurality of separate capillary channels embedded therein, each comprising a first end and a second end, wherein the first end is adapted to draw a predetermined volume of sample from a sample source;
a pressure source capable of operably connecting to the first ends of the plurality of separate capillary channels wherein the pressure source may effect a transfer of the predetermined volume of sample entirely from the first end to the second end; and
a support structure orienting the first ends as a first footprint and orienting the second ends as a second footprint, wherein the first footprint and second footprint have a different area.

47. The dispenser of claim 1 wherein an individual channel of said plurality is coated with a hydrophobic coating.

48. The dispenser of claim 47 wherein the individual channel comprises a tip that is coated with said hydrophobic coating.
